(19) United States
(12) Patent Application Publication
(10) Pub. No.: US 2019/0327931 A1
(43) Pub. Date: Oct. 31, 2019

(54) PET SUSPENSION HARNESS

(71) Applicant: Lizzette F. Mohr, St. John's, FL (US)

(72) Inventor: Lizzette F. Mohr, St. John's, FL (US)

(21) Appl. No.: 16/394,157

(22) Filed: Apr. 25, 2019

Related U.S. Application Data
(60) Provisional application No. 62/662,350, filed on Apr. 25, 2018.

(51) Int. Cl. A01K 1/02

(52) U.S. Cl. CPC A01K 1/0263; A01K 27/002; A01K 1/029

(57) ABSTRACT

An elevated pet suspension harness includes a front support, a rear support, and a mid-section coupled together. The front support includes a first leg opening, a second leg opening, and a neck opening. The rear support includes a third leg opening, a fourth leg opening, and a tail opening. The mid-section is made of a flexible and resilient material. A pair of straps are coupled the upper ends of the front support and the rear support. The upper ends of the front support, the rear support, and the mid-section define a gap therebetween sized to receive a pet.

### CROSS-REFERENCE TO RELATED APPLICATION

This application claims the benefit of priority of U.S. provisional application No. 62/662,350, filed Apr. 25, 2018, the contents of which are herein incorporated by reference.

### BACKGROUND OF THE INVENTION

The present invention relates to pet grooming and, more particularly, to a pet suspension harness used while grooming a pet and/or for administering medication.

Dog grooming refers to both the hygienic care and cleaning of a dog, as well as a process by which a dog's physical appearance is enhanced. Grooming is a vital part in the well-being and healthiness of a dog which can improve their lifespan. How much grooming a dog needs depends on its breed, age, and health. Regular grooming helps to ensure the dog is healthy and comfortable. Grooming a dog may include cutting nails, trimming hair, and cleaning. Some dogs become anxious and agitated during a grooming session, causing the dog to move uncontrollably, which makes grooming the dog very difficult.

As can be seen, there is a need for a pet suspension harness that suspends the dog in a comfortable manner for grooming.

### SUMMARY OF THE INVENTION

In one aspect of the present invention, an elevated pet suspension harness comprises: a front support comprising a U-shape having a bottom portion, upper ends, a front edge, and a rear edge, wherein the bottom portion comprises a first leg opening and a second leg opening and the front edge defines a neck opening; a rear support comprising a U-shape having a bottom portion, upper ends, a front edge, and a rear edge, wherein the bottom portion comprises a third leg opening and a fourth leg opening and the rear edge defines a tail opening; a mid-section comprising a U-shape having a bottom portion, upper ends, a front edge coupled to the rear edge of the front support and a rear edge coupled to the front edge of the rear support, wherein the mid-section is made of a flexible and resilient material, and a pair of straps coupled the upper ends of the front support and the rear support, wherein the upper ends of the front support, the rear support and the mid-section define a gap therebetween sized to receive a pet.

In another aspect of the present invention, an elevated pet suspension harness comprises: a front support comprising a U-shape having a bottom portion, upper ends, a front edge, and a rear edge, wherein the bottom portion comprises a first leg opening and a second leg opening and the front edge defines a neck opening; a rear support comprising a U-shape having a bottom portion, upper ends, a front edge, and a rear edge, wherein the bottom portion comprises a third leg opening and a fourth leg opening and the rear edge defines a tail opening; a front mesh coupled to the front edge at the bottom portion of the front support and a rear mesh coupled to the rear edge at the bottom portion of the rear support; a mid-section comprising a U-shape having a bottom portion, upper ends, a front edge coupled to the rear edge of the front support and a rear edge coupled to the front edge of the rear support, wherein the mid-section is made of a flexible and resilient material, and a pair of straps coupled the upper ends of the front support and the rear support, wherein the upper ends of the front support, the rear support, and the mid-section define a gap therebetween sized to receive a pet.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a perspective view of an embodiment of the present invention;

FIG. 3 is a side view of an embodiment of the present invention, shown in use;

FIG. 4 is a front view of an embodiment of the present invention, shown in use;

FIG. 5 is a rear view of an embodiment of the present invention, shown in use; and

FIG. 6 is a side view of an embodiment of the resent invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a harness that safely immobilizes small to medium size pets. The harness promotes safety and trust and further assists the user in transporting the pet from one area to another area as well as grooming the pet. The present invention allows a user to easily perform pedicures, grooming their head, brushing their teeth, cleaning the pet's ears, expressing glands, or other grooming procedures. The present invention safely and comfortably immobilizes the pet, causing a more pleasant experience for both the pet and the owner.

The present invention is an open bag that has four openings dedicated for the four pet legs to go through. The belly of the pet rests at the bottom of the bag, while the head and tail are exposed outside of the bag. A flap may be placed over the pet's back in order to secure the pet in place. An adjustable strap may be used to hang the present invention in an elevated position. The pet hangs safely and comfortably, so the owner or care taker can perform a pedicure, administer medication, or clean their ears, etc.

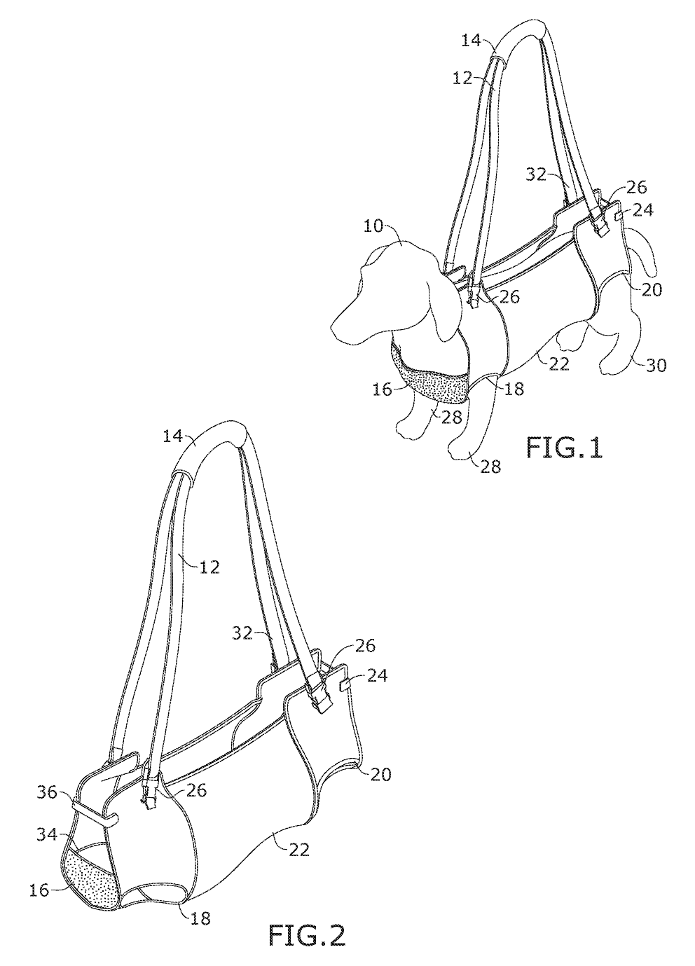

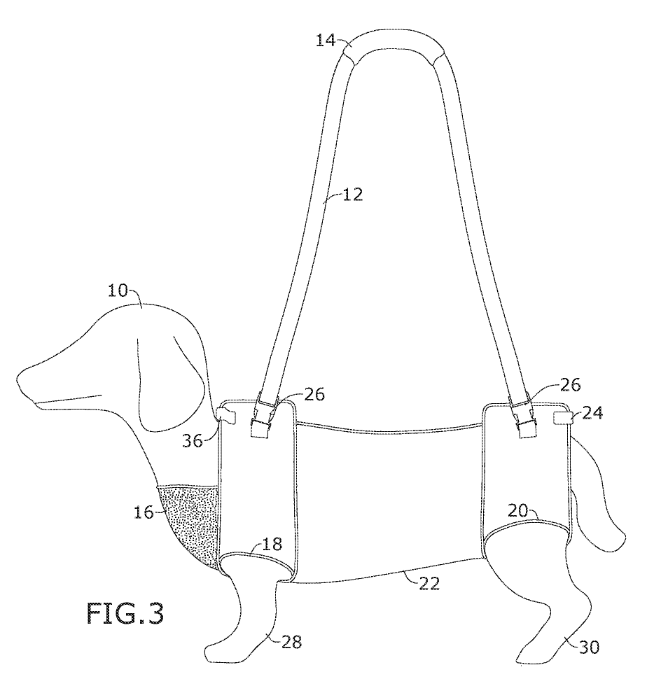

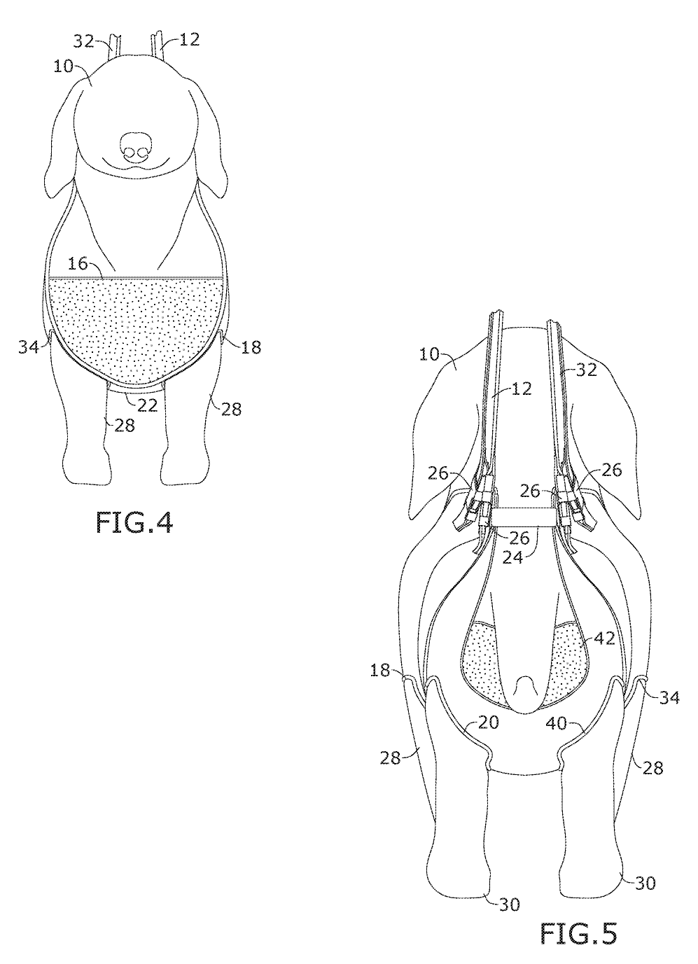

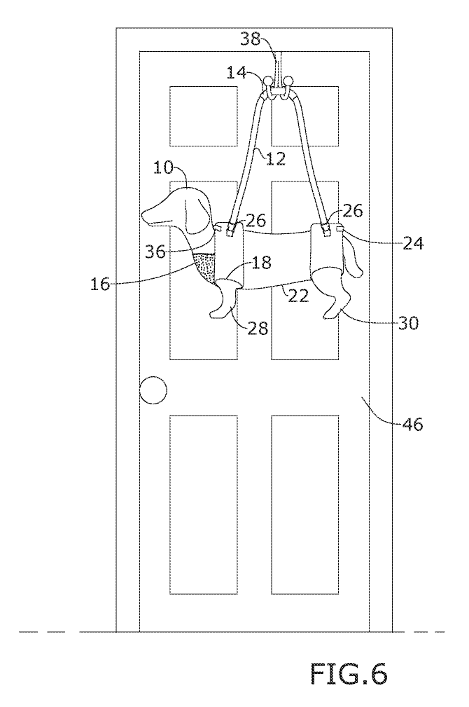

Referring to FIGS. 1 through 6, the present invention includes an elevated pet suspension harness. The harness includes a front support 48 and a rear support 50. The front support 48 includes a U-shape having a bottom portion, upper ends, a front edge, and a rear edge. The bottom portion of the front support 48 includes a first leg opening 18 and a second leg opening 34 and the front edge defines a neck opening. The rear support 50 includes a U-shape having a bottom portion, upper ends, a front edge, and a rear edge. The bottom portion of the rear support 50 includes a third leg opening 20 and a fourth leg opening 40 and the rear edge of the rear support 50 defines a tail opening.

A mid-section 22 includes a U-shape having a bottom portion, upper ends, a front edge coupled to the rear edge of the front support 48 and a rear edge coupled to the front edge of the rear support 50. The mid-section 22 is made of a flexible and resilient material, such as a natural or synthetic rubber. For example, the mid-section 22 may be made of neoprene. The upper ends of the front support 48, the rear support 50, and the mid-section 22 define a gap therebetween sized to receive a pet 10.

A pair of straps 12, 32 are coupled the upper ends of the front support 48 and the rear support 50. The pair of straps 12, 32 includes a first strap 12 and a second strap 32. The first strap 12 includes a first end coupled to the first support 48 at the upper ends and a second end coupled to the second support 50 at the upper ends. The second strap 32 includes a first end coupled to the first support 48 at the upper ends and a second end coupled to the second support 50 at the upper ends. Each of the pair of straps 12, 32 forms a loop. At a top end of the loops, the pair of straps 12, 32 are coupled together by a handle wrap 14. In certain embodiments, the pair of straps 12, 32 are releasably coupled to the front support 48 and the rear support 50. For example, buckles 26 releasably couple the pair of straps 12, 32 to the front support 48 and the rear support 50.

In certain embodiments, the present invention includes front mesh 16 coupled to the front edge at the bottom portion of the front support 48 and a rear mesh 42 coupled to the rear edge at the bottom portion of the rear support 50. The present invention may further include a front tab 36 releasably coupling the upper ends of the front support 48 together and a rear tab 24 releasably coupling the upper ends of the rear support 50 together. The front tab 36 and the rear tab 48 releasably couple the upper ends by a hook and loop fastener.

While in use, the pet 10 is placed through the gap of the upper ends so the front legs 28 of the pet 10 are within the first opening 18 and second opening 34 and the rear legs 30 are within the third opening 20 and the fourth opening 40. The mid-portion 22 stretches to the size of the pet 10. The user may buckle the straps 12, 32 to the first support 48 and the second support 50. The user may couple the upper ends of the first support 48 and the second support 50 together with the tabs 36, 24 to tighten the harness around the pet 10 securely. A hook 38 may be coupled to a door 46. The user hangs the elevated pet suspension harness from the hook 38 by the straps 12, 32 and handle wrap 14. The user is now able to easily groom the pet 10 while the pet 10 is still and comfortable.

It should be understood, of course, that the foregoing relates to exemplary embodiments of the invention and that modifications may be made without departing from the spirit and scope of the invention as set forth in the following claims.

What is claimed is:

1. An elevated pet suspension harness comprising:
a front support comprising a U-shape having a bottom portion, upper ends, a front edge, and a rear edge, wherein the bottom portion comprises a first leg opening and a second leg opening and the front edge defines a neck opening;
a rear support comprising a U-shape having a bottom portion, upper ends, a front edge, and a rear edge, wherein the bottom portion comprises a third leg opening and a fourth leg opening and the rear edge defines a tail opening;
a mid-section comprising a U-shape having a bottom portion, upper ends, a front edge coupled to the rear edge of the front support and a rear edge coupled to the front edge of the rear support, wherein the mid-section is made of a flexible and resilient material, and
a pair of straps coupled the upper ends of the front support and the rear support, wherein
the upper ends of the front support, the rear support and the mid-section define a gap therebetween sized to receive a pet.

2. The elevated pet suspension harness of claim 1, further comprising a front mesh coupled to the front edge at the bottom portion of the front support and a rear mesh coupled to the rear edge at the bottom portion of the rear support.

3. The elevated pet suspension harness of claim 1, further comprising a front tab releasably coupling the upper ends of the front support together and a rear tab releasably coupling the upper ends of the rear support together.

4. The elevated pet suspension harness of claim 3, wherein the front tab and the rear tab releasably couple the upper ends by a hook and loop fastener.

5. The elevated pet suspension harness of claim 1, wherein the pair of straps are releasably coupled to the front support and the rear support.

6. The elevated pet suspension harness of claim 5, further comprising buckles releasably coupling the pair of straps to the front support and the rear support.

7. An elevated pet suspension harness comprising:
a front support comprising a U-shape having a bottom portion, upper ends, a front edge, and a rear edge, wherein the bottom portion comprises a first leg opening and a second leg opening and the front edge defines a neck opening;
a rear support comprising a U-shape having a bottom portion, upper ends, a front edge, and a rear edge, wherein the bottom portion comprises a third leg opening and a fourth leg opening and the rear edge defines a tail opening;
a front mesh coupled to the front edge at the bottom portion of the front support and a rear mesh coupled to the rear edge at the bottom portion of the rear support;
a mid-section comprising a U-shape having a bottom portion, upper ends, a front edge coupled to the rear edge of the front support and a rear edge coupled to the front edge of the rear support, wherein the mid-section is made of a flexible and resilient material, and
a pair of straps coupled the upper ends of the front support and the rear support, wherein
the upper ends of the front support, the rear support, and the mid-section define a gap therebetween sized to receive a pet.

8. The elevated pet suspension harness of claim 7, further comprising a front tab releasably coupling the upper ends of the front support together by a first hook and loop fastener and a rear tab releasably coupling the upper ends of the rear support together by a second hook and loop fastener.

9. The elevated pet suspension harness of claim 7, wherein the pair of straps are releasably coupled to the front support and the rear support.

10. The elevated pet suspension harness of claim 9, further comprising buckles releasably coupling the pair of straps to the front support and the rear support.
